(19) United States
(12) Patent Application Publication
(10) Pub. No.: US 2026/0244024 A1
(43) Pub. Date: Aug. 20, 2026

(54) OPTICAL WAVEGUIDE STRUCTURE AND AUGMENTED REALITY DISPLAY DEVICE

(71) Applicants: Interface Advanced Technology (Chengdu) Co., Ltd., Chengdu (CN); Interface Technology (ChengDu) Co., Ltd., Chengdu (TW); INTERFACE OPTOELECTRONICS (SHENSHEN) CO., LTD., Shenzhen (CN); GENERAL INTERFACE SOLUTION LIMITED, Zhunan (TW)

(72) Inventors: PO-HAO CHEN, Zhunan (TW); Pei-chu Tsai, Zhunan (TW)

(21) Appl. No.: 19/649,346

(22) Filed: Apr. 16, 2026

Related U.S. Application Data
(63) Continuation-in-part of application No. PCT/CN2024/137812, filed on Dec. 9, 2024.

(51) Int. Cl. G02B 27/01; F21V 8/00

(52) U.S. Cl. CPC G02B 27/0172; G02B 6/0026; G02B 6/005; G02B 2027/0123

(57) ABSTRACT

A light waveguide structure includes a first waveguide having opposite first and second surfaces, a first in-coupling grating, and a first out-coupling grating. The first waveguide guides sub-image light within a first wavelength range along a first direction. The first in-coupling grating is on the first surface to receive image light and couple the sub-image light of the first wavelength range into the waveguide, with its grating direction forming a non-zero first angle with the first direction. The first out-coupling grating receives and outputs the sub-image light from the waveguide, with its grating direction forming a non-zero second angle with the first direction and being opposite to that of the first in-coupling grating. An augmented reality display device including the light waveguide structure is also provided.

### BACKGROUND

With the development of technology, augmented reality (AR) technology has been applied in various fields such as gaming, education, medical, retail, and retail. AR display devices project computer-generated virtual images through a display module and an optical waveguide structure to the human eye, superimposing virtual images on real-world scenes to create a display effect that merges virtuality and reality. Currently, common AR display devices on the market mainly adopt one-dimensional pupil expansion technology to expand the horizontal field of view (FOV), allowing the user’s eye to see the displayed image when moving horizontally.

However, the one-dimensional pupil expansion technology is difficult to expand the vertical field of view. Furthermore, when the image light is transmitted from an in-coupling grating to an out-coupling grating, since the image light includes sub-image lights having different wavelength ranges, the light within different wavelength ranges gradually shift in different directions away from the central axis of the optical waveguide structure. This results in an incomplete display image received by the human eye in the vertical direction, and the display image seen by the user’s eyes when moving in the vertical direction is incomplete, thereby reducing the field of view in the vertical direction and affecting the display effect.

Therefore, there is room for improvement in the art.

### BRIEF DESCRIPTION OF THE DRAWINGS

Implementations of the present disclosure will now be described, by way of embodiment, with reference to the attached figures.

FIG. 1 is a schematic structural diagram of an embodiment of an optical waveguide structure according to the present disclosure.

FIG. 2 illustrates light paths in the optical waveguide structure shown in FIG. 1.

FIG. 3 illustrates, for the optical waveguide structure shown in FIG. 1, a first included angle between a grating direction of a first in-coupling grating and a first direction and a second included angle between a grating direction of a first out-coupling grating and the first direction.

FIG. 4 is a schematic diagram of an angular space between the grating direction of the first in-coupling grating and the grating direction of the first out-coupling grating in the optical waveguide structure shown in FIG. 1.

FIG. 5 is a schematic diagram of an optical waveguide structure of a comparative example of the present disclosure.

FIG. 6 is a schematic diagram of an angular space between a grating direction of an in-coupling grating and a grating direction of an out-coupling grating in the optical waveguide structure shown in FIG. 5.

FIG. 7 illustrates, for the optical waveguide structure shown in FIG. 1, a third included angle between a grating direction of a second in-coupling grating and the first direction and a fourth included angle between a grating direction of a second out-coupling grating and the first direction.

FIG. 8 is a schematic structural diagram of another embodiment of an optical waveguide structure according to the present disclosure.

FIG. 9 is a schematic diagram of an optical path of an exposure system according to an embodiment of the present disclosure.

FIG. 10 is a schematic diagram of an embodiment of an augmented reality display device according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”.

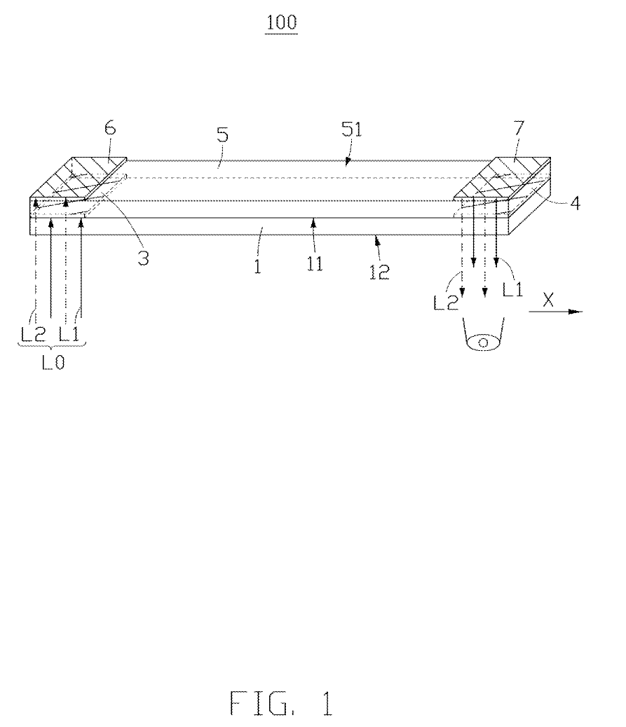

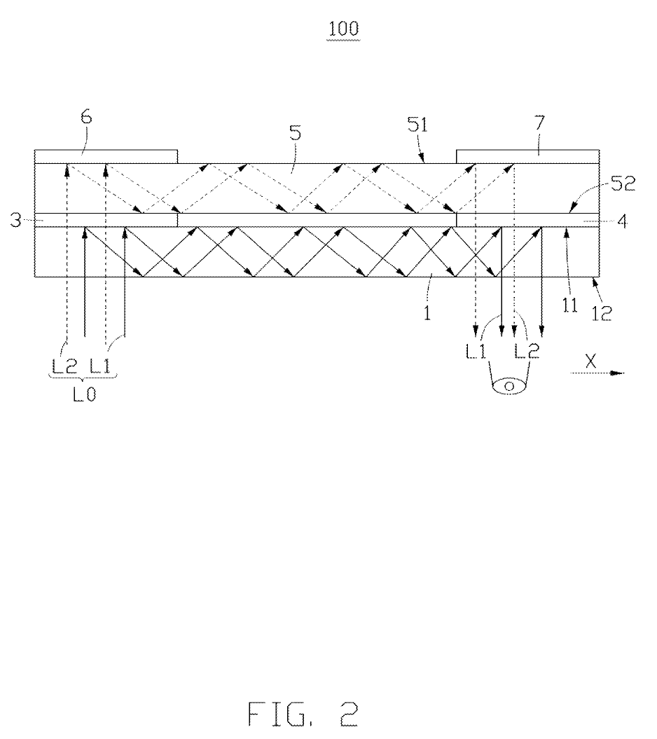

As shown in FIGS. 1 and 2, an optical waveguide structure 100 according to an embodiment includes a first waveguide 1, a first in-coupling grating 3, a first out-coupling grating 4, a second waveguide 5, a second in-coupling grating 6, and a second out-coupling grating 7.

The first in-coupling grating 3 and the first out-coupling grating 4 are on a surface of the first waveguide 1 and spaced apart from each other. The second waveguide 5 is attached to a side of the first in-coupling grating 3 and the first out-coupling grating 4 away from the first waveguide 1. The second in-coupling grating 6 and the second out-coupling grating 7 are on a surface of the second waveguide 5 away from the first waveguide 1 and spaced apart from each other.

In some embodiments, the first waveguide 1 is substantially plate-shaped and has a first surface 11 and a second surface 12 opposite to the first surface 11. The first surface 11 and the second surface 12 each has a substantially rectangular outer contour. The first waveguide 1 extends along a first direction X. That is, a long edge of the first surface 11 or the second surface 12 extends along the first direction X.

In some embodiments, a material of the first waveguide 1 is transparent glass or plastic, such as polyethylene glycol terephthalate (PET), polycarbonate (PC), and polymethyl methacrylate (PMMA).

In some embodiments, a refractive index of the first waveguide 1 ranges from 1.3 to 2.5. For example, the refractive index of the first waveguide 1 may be, but not limited to, any value within the ranges of 1.3 to 1.5, 1.5 to 1.7, 1.7 to 1.9, 1.9 to 2.1, 2.1 to 2.3, and 2.3 to 2.5.

The first waveguide 1 is configured to receive and guide a portion of image light L0, incident from the first in-coupling grating 3, to propagate along the first direction X.

In some embodiments, the first waveguide 1 is configured to receive and guide a first sub-image light L1 within a first wavelength range, incident from the first in-coupling grating 3, to propagate along the first direction X.

In some embodiments, the image light L0 includes a plurality of sub-image lights, each having a different wavelength range. The image light L0 includes the first sub-image light L1 and a second sub-image light L2 within a different wavelength range from the first sub-image light L1.

For example, the first sub-image light L1 within a first wavelength range may be red light, and the second sub-image light L2 within a second wavelength range may be blue light. The first wavelength range may be 760 nm to 622 nm, and the second wavelength range may be 450 nm to 435 nm.

In other embodiments, the image light L0 may be monochromatic light, i.e., the wavelength ranges of the first sub-image light L1 and the second sub-image light L2 are the same. The first waveguide 1 is configured to receive and guide the first sub-image light L1 within the first wavelength range incident from the first in-coupling grating 3, and the second waveguide 5 is configured to receive and guide the second sub-image light L2 within the second wavelength range incident from the second in-coupling grating 6.

In yet other embodiments, the image light L0 may include a plurality of sub-image lights within different wavelength ranges, and the first waveguide 1 and the second waveguide 5 may be configured to receive and guide sub-image light within one or more wavelength ranges incident from the first in-coupling grating 3 or the second in-coupling grating 6.

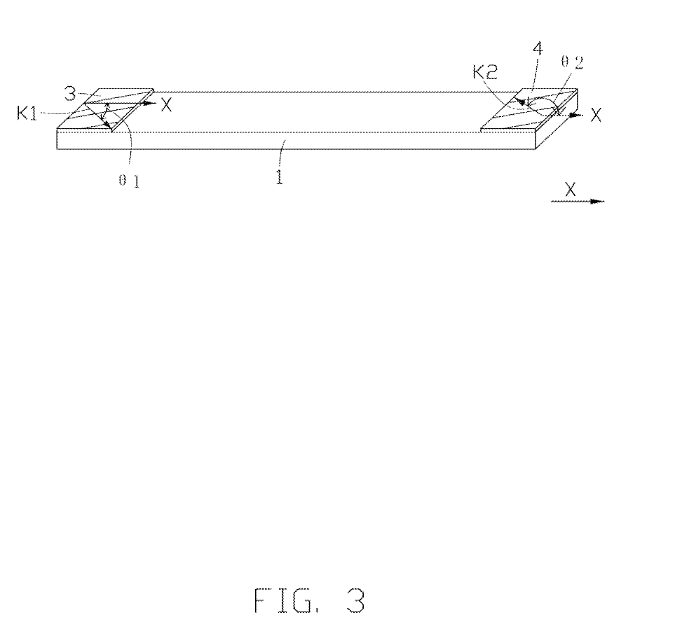

As shown in FIGS. 2 and 3, the first in-coupling grating 3 is on the first surface 11 of the first waveguide 1. In some embodiments, the first in-coupling grating 3 can be bonded to the first surface 11 of the first waveguide 1 using an optical adhesive. The first in-coupling grating 3 is configured to receive and couple the first sub-image light L1 into the first waveguide 1.

In some embodiments, when image light L0 including different wavelength ranges is incident on the first in-coupling grating 3, since the wavelength range of the first sub-image light L1 is different from the wavelength range of the second sub-image light L2, the sub to image light L1 is incident on the first in-coupling grating 3, which receives and couples the first sub-image light L1 into the first waveguide 1, while the second sub-image light L2 passes through the first in-coupling grating 3 and is incident on the second in-coupling grating 6.

In other embodiments, the wavelength ranges of the first sub-image light L1 and the second sub-image light L2 are the same, a portion of the image light L0 (first sub-image light L1) is incident on the first in-coupling grating 3, which receives and couples the first sub-image light L1 into the first waveguide 1, and the first sub-image light L1 is then coupled out to the human eye through the first out-coupling grating 4. Another portion of the image light L0 (second sub-image light L2) passes through the first in-coupling grating 3 and is incident on the second in-coupling grating 6, which receives and couples the second sub-image light L2 into the second waveguide 5, and the second sub-image light L2 is then coupled out to the human eye through the second out-coupling grating 7.

The intensity of light incident into the first waveguide 1 and the second waveguide 5 can be adjusted by adjusting the diffraction efficiency of the first in-coupling grating 3, thereby adjusting the intensity of light emitted from the first out-coupling grating 4 and the second out-coupling grating 7, further improving the uniformity of the light intensity emitted from the optical waveguide structure 100.

In some embodiments, the first in-coupling grating 3 is a holographic diffraction grating, such as an amplitude grating or a phase grating. The grating period of the first in-coupling grating 3 ranges from 0.1 μm to 10 μm. For example, the grating period may be, but not limited to, any value within the ranges of 0.1 μm to 1 μm, 1 μm to 3 μm, 3 μm to 5 μm, 5 μm to 7 μm, 7 μm to 8 μm, and 8 μm to 10 μm.

In some embodiments, the first in-coupling grating 3 is has a surface with periodically alternating bright and dark stripes arranged approximately parallel to each other.

In other embodiments, the first in-coupling grating 3 may be, but not limited to, other gratings having periodic structures, or gratings with periodically varying refractive indices.

In some embodiments, the alternating bright and dark stripes of the first in-coupling grating 3 are approximately parallel, and the grating direction of the first in-coupling grating 3 is perpendicular to the extension direction of the stripes. The grating direction of the first in-coupling grating 3 also refers to the periodic direction of the grating, i.e., the grating extension order direction, or the vector direction of the grating projected on the first surface 11.

A grating direction K1 of the first in-coupling grating 3 has a first angle θ1 relative to the first direction X. The first angle θ1 satisfies: -15° ≤ θ1 < 0° or 0° < θ1 ≤ 15°. For example, the first angle θ1 may be selected from, but not limited to, any value within the ranges of -15° ≤ θ1 ≤ -10°, -10° ≤ θ1 < 0°, 0° < θ1 ≤ 10°, and 10° ≤ θ1 ≤ 15°.

By setting the first angle θ1 within the above range, the offset of the emission position of the first sub-image light L1 on the first out-coupling grating 4 relative to the central axis of the first waveguide 1 can be partially offset, while preventing excessive offset of the first sub-image light L1 that would result in an offset error.

The first in-coupling grating 3 and the first out-coupling grating 4 are arranged along the first direction X. The first out-coupling grating 4 and the first in-coupling grating 3 are spaced apart on the first surface 11. The first out-coupling grating 4 may be bonded to the first surface 11 of the first waveguide 1 using an optical adhesive. The first out-coupling grating 4 is configured to receive and couple the first sub-image light L1 within the first wavelength range out of the first waveguide 1.

In some embodiments, the first out-coupling grating 4 is a holographic diffraction grating, such as an amplitude grating or a phase grating.

In some embodiments, the first out-coupling grating 4 has a surface with periodically alternating bright and dark stripes.

In other embodiments, the first out-coupling grating 4 may be other gratings having periodic structures or gratings with periodic refractive index variation. The grating period of the first out-coupling grating 4 ranges from 0.1 μm to 10 μm. The grating period of the first out-coupling grating 4may be, but not limited to, any value within the ranges of 0.1 μm to 1 μm, 1 μm to 3 μm, 3 μm to 5 μm, 5 μm to 7 μm, 7 μm to 8 μm, and 8 μm to 10 μm.

A grating direction K2 of the first out-coupling grating 4 is parallel to the grating direction K1 of the first in-coupling grating 3, and opposite in orientation.

The grating direction K2 has a second angle θ2 relative to the first direction X. The second angle θ2 satisfies: -180° < θ2 ≤ -165° or 165° ≤ θ2 < 180°. For example, the second angle θ2 may be, but not limited to, any value within the ranges of -180° < θ2 ≤ -170°, -170° ≤ θ2 ≤ -165°, 165° ≤ θ2 ≤ 170°, and 170° ≤ θ2 < 180°, as long as the grating directions K2 and the grating directions K1 are parallel and opposite, and the magnitudes of the first angle θ1 and the second angle θ2 are equal. By setting the second angle θ2 within the above range, the offset of the emission position of the first sub-image light L1 on the first out-coupling grating 4 relative to the central axis of the first waveguide 1 can be partially offset without causing excessive offset error.

To ensure that the grating direction K2 of the first out-coupling grating 4 is parallel to the grating direction K1 of the first in-coupling grating 3, the first angle θ1 is a negative angle, and the second angle θ2 is a positive angle. In other embodiments, the first angle θ1 is a positive angle, and the second angle θ2 is a negative angle.

In some embodiments, neither the first angle θ1 nor the second angle θ2 is zero, i.e., the grating direction K1 of the first in-coupling grating 3 and the grating directions K2 of the first out-coupling grating 4 each form angles with respect to the first direction X.

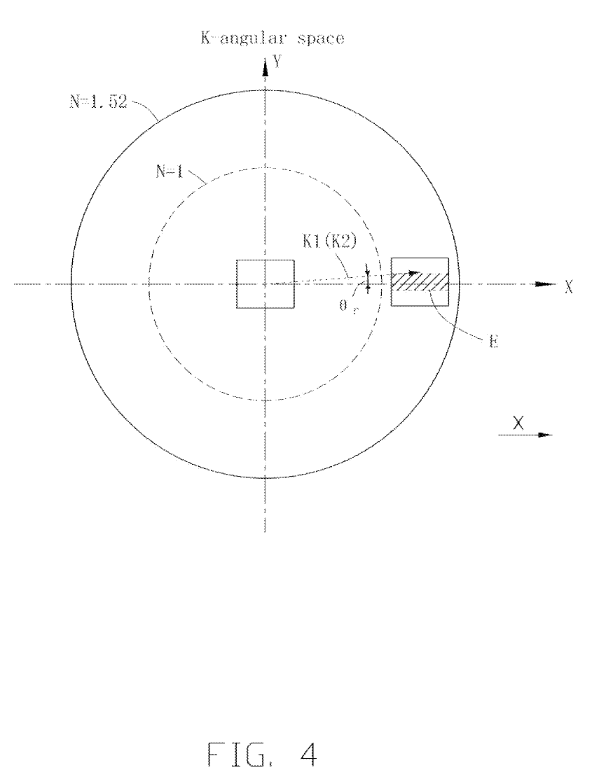

As shown in FIG. 4, which is a schematic angular space diagram of the grating direction K1 and the grating direction K2. FIG. 4 illustrates the case where the first angle θ1 is 3° or the second angle θ2 is -177°. The grating direction K1 is parallel to the grating direction K2, and the magnitude of θ1 equals the magnitude of θ2. The angle between the extension of the grating directions K1 and K2 and the first direction X is defined as a vector angle θr.

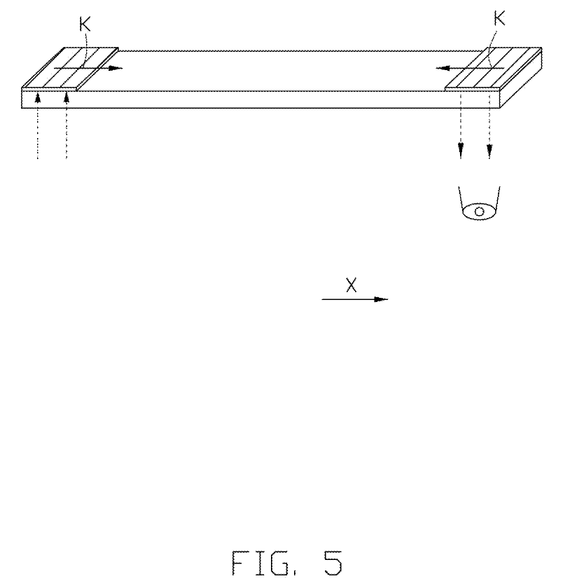

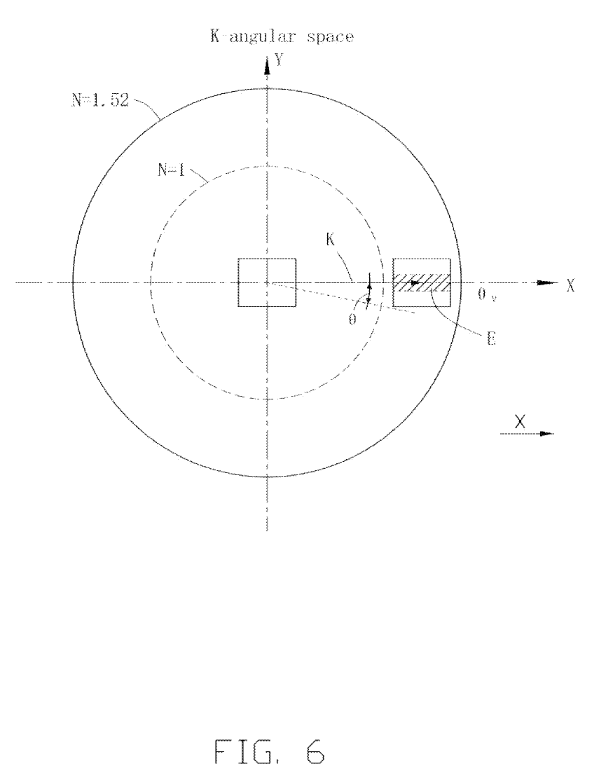

As shown in FIGS. 5 and 6, in a comparative optical waveguide structure, the first angle θ1 and the second angle θ2 are both zero, that is, the grating direction of the in-coupling grating is parallel to the first direction X, and the grating direction of the out-coupling grating is also parallel to the first direction X. When light transfers from the in-coupling grating to the out-coupling grating, the light gradually offsets in different directions away from the central axis of the optical waveguide structure, creating an offset angle θ relative to the first direction X. Please refer to FIG. 6, which is a schematic diagram of an angular space showing of an in-coupling grating and a grating direction of an out-coupling grating in the comparative example. Since both the first angle θ1 and the second angle θ2 are zero , the extension directions of the grating directions of the in-coupling and out-coupling gratings have the vector angle θr of zero with the first direction X. Due to the offset angle θ, the vertical light emission relative to the first direction X cannot be received in a visible region E of the human eye.

As shown in FIGS. 1 and 2, in the optical waveguide structure 100, by setting the first angle θ1 and the second angle θ2 to be non-zero, extension directions of the grating directions of the first in-coupling grating 3 and the first out-coupling grating 4 form non-zero angles with the first direction X, so the vector angle θr is also non-zero.

When the first sub-image light L1 within the first wavelength range offsets away from the central axis of the optical waveguide structure 100, i.e., the emission position of sub-image light L1 relative to the first direction X at the first out-coupling grating 4 forms an offset angle θ, the existence of the vector angle θr can offset part of this influence.

Namely, the actual offset angle of the first sub-image light L1 at the emission position of the first out-coupling grating 4 relative to the first direction X is θ-θr. The magnitude of θ-θr is less than the field of view (FOV) angle in the vertical direction perpendicular to the first direction X receivable by the eye visible region E. Thus, the eye visible region E can receive the first sub-image light L1 emitted in the vertical direction, thereby increasing the FOV in the vertical direction perpendicular to the first direction X without affecting the overall volume of the optical waveguide structure 100.

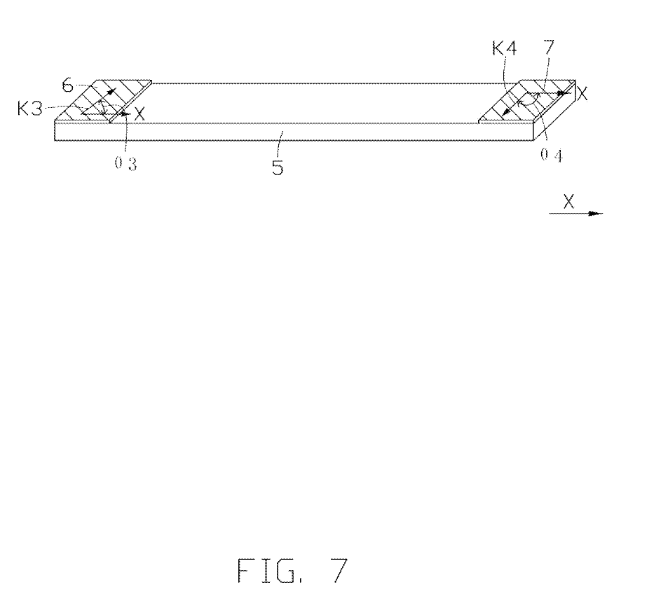

As shown in FIGS. 1, 2, and 7, the second waveguide 5 has a substantially plate-like structure and includes a third surface 51 and a fourth surface 52 opposite to the third surface 51. The third surface 51 and the fourth surface 52 have a substantially rectangular outer contour. The second waveguide 5 is attached to a side of the first waveguide 1 and covers the first in-coupling grating 3 and the first out-coupling grating 4. That is, the fourth surface 52 is attached to a side of the first in-coupling grating 3 and the first out-coupling grating 4 away from the first waveguide 1.

In some embodiments, the second waveguide 5 extends along a first direction X; that is, long sides of the third surface 51 or the fourth surface 52 extend along the first direction X. The second waveguide 5 is configured to receive and guide the second sub-image light L2 within the second wavelength range, incident from the second in-coupling grating 6.

In some embodiments, a material of the second waveguide 5 is transparent glass or plastic, such as PET, PC, or PMMA.

In some embodiments, a refractive index of the second waveguide 5 ranges from 1.3 to 2.5. For example, the refractive index of the second waveguide 5 may be, but not limited to, any value within the ranges of 1.3 to 1.5, 1.5 to 1.7, 1.7 to 1.9, 1.9 to 2.1, 2.1 to 2.3, and 2.3 to 2.5.

The second in-coupling grating 6 is on the third surface 51. In some embodiments, the second in-coupling grating 6 can be bonded to the third surface 51 of the second waveguide 5 using an optical adhesive. The second in-coupling grating 6 is configured to receive and couple the second sub-image light L2 within the second wavelength range into the second waveguide 5.

In some embodiments, when image light L0 including different wavelength ranges is incident on the second in-coupling grating 6, since the wavelength range of the first sub-image light L1 is different from the wavelength range of the second sub-image light L2, the first sub-image light L1 is incident on the first in-coupling grating 3, and the second sub-image light L2 passes through the first in-coupling grating 3 and is incident on the second in-coupling grating 6.

In other embodiments, when the wavelength ranges of the first sub-image light L1 and the second sub-image light L2 are the same, a portion of the image light L0 (i.e., first sub-image light L1) is incident on the first in-coupling grating 3, which receives and couples the first sub-image light L1 into the first waveguide 1, and the first sub-image light L1 is then coupled out to the human eye through the first out-coupling grating 4. Another portion of the image light L0 (i.e., second sub-image light L2) passes through the first in-coupling grating 3 and is incident on the second in-coupling grating 6, which receives and couples the second sub-image light L2 into the second waveguide 5, and the second sub-image light L2 is then coupled out to the human eye through a second out-coupling grating 7.

The diffraction efficiency of the first in-coupling grating 3 may be adjusted to control the intensity of light incident on the first waveguide 1 and the second waveguide 5, thereby adjusting the intensity of light emitted from the first out-coupling grating 4 and second out-coupling grating 7 and improving the uniformity of the light intensity emitted from the optical waveguide structure 100.

In some embodiments, the second in-coupling grating 6 is a holographic diffraction grating, such as an amplitude grating or a phase grating.

In some embodiments, the second in-coupling grating 6 has alternating bright and dark stripes with a periodic pattern on its surface.

In other embodiments, the second in-coupling grating 6 may be, but not limited to, a grating with other periodic structures or a grating with periodic refractive index variation. The grating period of the second in-coupling grating 6 ranges from 0.1 μm to 10 μm. For example, the grating period of the second in-coupling grating 6 may be, but not limited to, any value within the ranges of 0.1 μm to 1 μm, 1 μm to 3 μm, 3 μm to 5 μm, 5 μm to 7 μm, 7 μm to 8 μm, and 8 μm to 10 μm.

A grating direction K3 of the second in-coupling grating 6 is opposite to a grating direction K4 of the second out-coupling grating 7. The grating direction K3 of the second in-coupling grating 6 has a third angle θ3 relative to the first direction X. The third angle θ3 satisfies: -15° ≤ θ3 < 0° or 0° < θ3 ≤ 15°. For example, the third angle θ3 may be, but not limited to, any value within the ranges of -15° ≤ θ3 ≤ -10°, -10° ≤ θ3 < 0°, 0° < θ3 ≤ 10°, and 10° ≤ θ3 ≤ 15°.

The second in-coupling grating 6 and the second out-coupling grating 7 are arranged along the first direction X. The second out-coupling grating 7 and the second in-coupling grating 6 are spaced apart from each other on the third surface 51.

In some embodiments, the second out-coupling grating 7 can be bonded to the third surface 51 of the second waveguide 5 using an optical adhesive. The second out-coupling grating 7 is configured to receive and couple out the second sub-image light L2 emitted from the second waveguide 5.

In some embodiments, the second out-coupling grating 7 is a holographic diffraction grating, and may be an amplitude grating or a phase grating.

In some embodiments, the second out-coupling grating 7 has alternating bright and dark stripes with a periodic pattern on its surface.

In other embodiments, the second out-coupling grating 7 may be, but not limited to, a grating with other periodic structures or a grating with periodic refractive index variation. The grating period of the second out-coupling grating 7 ranges from 0.1 μm to 10 μm. For example, the grating period of the second out-coupling grating 7 may be, but not limited to, any value within the ranges of 0.1 μm to 1 μm, 1 μm to 3 μm, 3 μm to 5 μm, 5 μm to 7 μm, 7 μm to 8 μm, and 8 μm to 10 μm.

The grating direction K4 of the second out-coupling grating 7 has a fourth angle θ4 relative to the first direction X. The fourth angle θ4 satisfies: -180° < θ4 ≤ -165° or 165° ≤ θ4 < 180°. For example, the fourth angle θ4 may be, but not limited to, any value within the ranges of -180° < θ4 ≤ -170°, -170° ≤ θ4 ≤ -165°, 165° ≤ θ4 ≤ 170°, and 170° ≤ θ4 < 180°. The grating direction K4 is opposite to the grating direction K3, and the polarities (positive/negative) of the fourth angle θ4 and the second angle θ2 are opposite, and the grating direction K1 is opposite to the grating direction K2.

In some embodiments, to prevent interference between the first sub-image light L1 emitted from the first out-coupling grating 4 and the second sub-image light L2 emitted from the second out-coupling grating 7, the first angle θ1 is negative, the second angle θ2 is positive, the third angle θ3 is positive, and the fourth angle θ4 is negative.

In other embodiments, the first angle θ1 may be positive, the second angle θ2 may be negative, the third angle θ3 may be negative, and the fourth angle θ4 may be positive.

As shown in FIGS. 2, 4, and FIG. 7, the angle between the extension direction K3 of the grating directions of the second in-coupling grating 6 and the extension direction K4 of the second out-coupling grating 7 with the first direction X is defined as a vector angle θr. In the optical waveguide structure 100, by setting the third angle θ3 and the fourth angle θ4 to be non-zero, the vector angle θr is also non-zero. When the second sub-image light L2 having the second wavelength range offsets in different directions away from the central axis of the optical waveguide structure 100, creating an offset angle θ relative to the first direction X at the emission position of the second out-coupling grating 7, the existence of the vector angle θr can offset part of the influence of the offset angle θ.

That is, the actual offset angle of the second sub-image light L2 at the emission position of the second out-coupling grating 7 relative to the first direction X is θ-θr. The magnitude of θ-θr is smaller than the field of view (FOV) angle in the vertical direction receivable by the human eye visible region E. Thus, the second sub-image light L2 emitted in the vertical direction perpendicular to the first direction X can be received in the human eye visible region E, thereby increasing the vertical FOV without affecting the overall volume of the optical waveguide structure 100.

In the optical waveguide structure 100, by providing the second waveguide 5, the second in-coupling grating 6, and the second out-coupling grating 7, the grating directions K3 and K4 have an angle relative to the first direction X. This can reduce the angle at which the second sub-image light L2 offsets toward the central axis of the optical waveguide structure 100 during transmission from the second in-coupling grating 6 to the second out-coupling grating 7. That is, the offset angle θ of the sub-image light (L1 and L2, where the first and second wavelength ranges are the same or different) during transmission can be reduced, thereby increasing the FOV in the vertical direction perpendicular to the first direction X without affecting the overall volume.

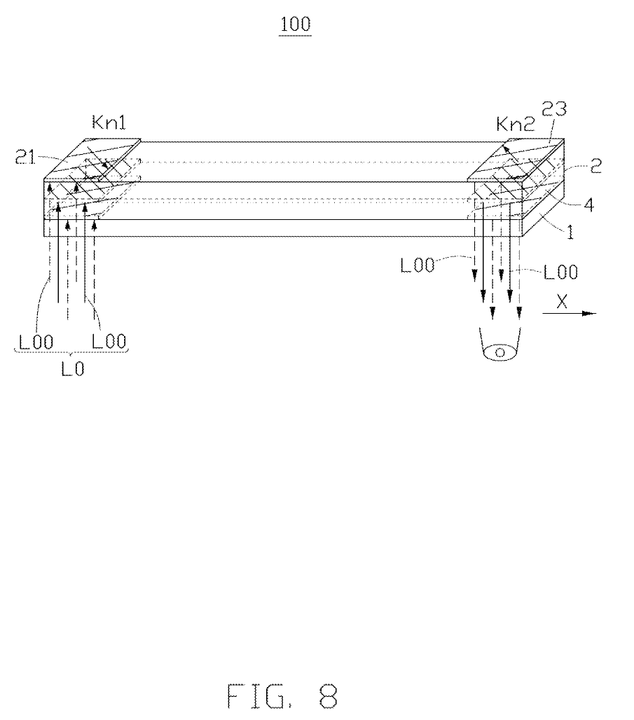

As shown in FIG. 8, the optical waveguide structure 100 includes a plurality of waveguides 2 stacked on the first waveguide 1. Each waveguide 2 has an in-coupling grating 21 and an out-coupling grating 23 on a side away from the first waveguide 1. The in-coupling grating 21 and the out-coupling grating 23 in the same waveguide 2 are arranged along the first direction X. Different waveguides 2 are configured to receive and guide sub-image light L00 having different wavelength ranges to propagate along the first direction X.

A grating direction Kn1 of each in-coupling grating 21 has a non-zero angle relative to the first direction X. A grating direction Kn2 of each out-coupling grating 23 also has a non-zero angle relative to the first direction X. The grating direction Kn1 of each in-coupling grating 21 is opposite to the grating direction Kn2 of each out-coupling grating 23.

By providing the stacked waveguides 2, the offset angle θ of sub-image light L00 having different wavelength ranges can be reduced during transmission from the in-coupling grating 21 to the out-coupling grating 23, thereby increasing the vertical FOV without affecting the overall volume of the optical waveguide structure 100.

In other embodiments, the image light L0 includes sub-image light L0 of a single wavelength range, the optical waveguide structure 100 may include the first waveguide 1, the first in-coupling grating 3, and the first out-coupling grating 4, but does not include the stacked waveguides 2.

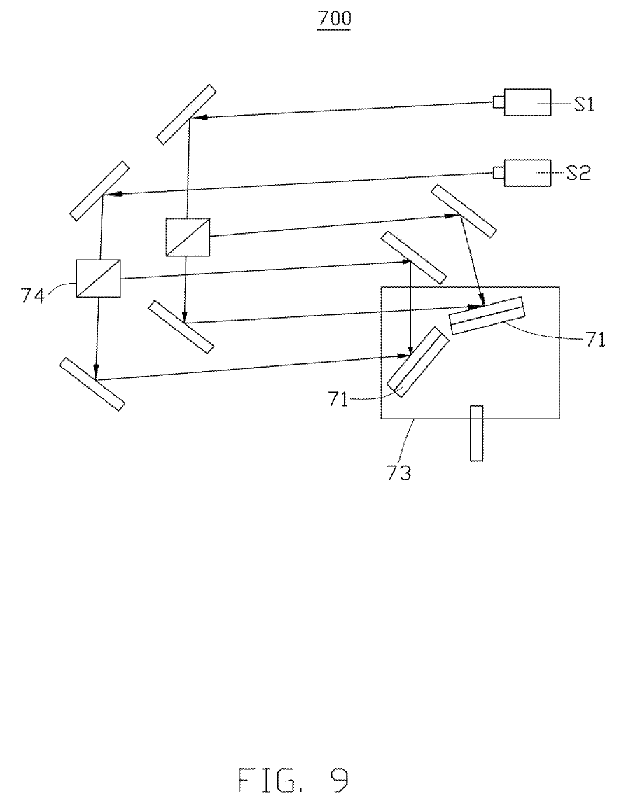

FIG. 9 illustrates an exposure optical path 700 used for fabricating any one of the holographic diffraction gratings among the first in-coupling grating 3, the first out-coupling grating 4, the second in-coupling grating 6, and the second out-coupling grating 7.

As shown in FIG. 9, light from an exposure light source S1 or S2 passes through a beamsplitter 74 to be split into two sub-beams of equal intensity. Each sub-beam is reflected by a mirror onto a grating negative 71. The two sub-beams interfere on the grating negative 71 to form interference fringes.

Since a base 73 holding the grating negative 71 is rotatable, the parallel angle of the interference fringes formed on the negative 71 can be adjusted, thereby adjusting the grating direction of the resulting holographic diffraction grating. This allows for the simultaneous exposure and fabrication of the first in-coupling grating 3 and the first out-coupling grating 4, or the second in-coupling grating 6 and the second out-coupling grating 7.

In the optical waveguide structure 100, by setting the grating direction K1 of the first in-coupling grating 3 to be parallel to the grating direction K2 of the first out-coupling grating 4, and ensuring the grating direction K1 and the grating direction K2 are opposite, while the first angle θ1 of the grating direction K1 and the second angle θ2 of the grating direction K2 relative to the first direction X are non-zero, the angle of the grating directions relative to the first direction X is increased. This reduces the offset angle of the first sub-image light L1 toward the central axis during propagation from the first in-coupling grating 3 to the first out-coupling grating 4. Thus, the vertical FOV is increased.

When applied to an augmented reality (AR) display device 900, this increased the FOV in the vertical direction perpendicular to the first direction X allows the user’s eye to receive first sub-image light L1 in the vertical direction, enabling the user to see the displayed image even when the eye moves vertically, thereby enhancing the display effect without increasing the device volume.

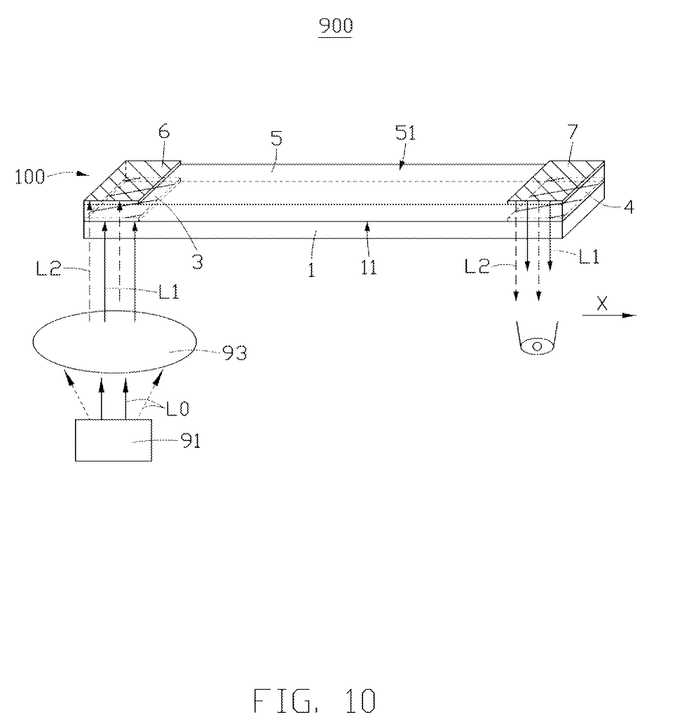

As shown in FIGS. 2 and 10, the AR display device 900 includes a display module 91 and the optical waveguide structure 100. The display module 91 is configured to emit image light L0, which includes multiple sub-image lights of different wavelength ranges.

For example, the first sub-image light L1 may be red light and the second sub-image light L2 may be blue light. Due to the different wavelength ranges, the first sub-image light L1 is coupled into the first waveguide 1 by the first in-coupling grating 3, while the second sub-image light L2 passes through the first in-coupling grating 3 and is coupled into the second waveguide 5 by the second in-coupling grating 6.

In other embodiments, the wavelength ranges of the first sub-image light L1 and the second sub-image light L2 are the same, part of image light L0 (i.e., L1) enters the first in-coupling grating 3, which couples L1 into the first waveguide 1 and then couples it out to the eye via the first out-coupling grating 4. Another part of image light L0 (i.e., L2) passes through the first in-coupling grating 3, enters the second in-coupling grating 6, which couples L2 into the second waveguide 5, and is coupled out to the eye through the second out-coupling grating 7.

In some embodiments, the display module 91 may be a Digital Light Processor (DLP) display, or a light-emitting diode (LED) panel, such as a Micro-OLED or Micro-LED panel. The AR display device 900 further includes a collimating module 93 on the output side of the display module 91 to converge and transmit the image light L0 to the optical waveguide structure 100.

The AR display device 900 uses the optical waveguide structure 100, with the first angle θ1 of the grating direction K1 of the first in-coupling grating 3 relative to the first direction X and the second angle θ2 of the grating direction K2 of the first out-coupling grating 4 relative to the first direction X both non-zero, and K1 and K2 opposite. Thus, the angle between the grating directions K1 and K2 relative to the first direction X is increased, reducing the offset angle θ of sub-image light L1 during transmission inside the optical waveguide. This enlarges the vertical field-of-view angle perpendicular to the first direction X, allowing the user’s eyes to receive vertically-directed sub-image light L1, enabling viewing while moving vertically without increasing overall device volume, thereby enhancing display effect.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. An optical waveguide structure comprising:
a first waveguide comprising a first surface and a second surface opposite to each other, the first waveguide configured to guide a first sub-image light within a first wavelength range along a first direction;
a first in-coupling grating on the first surface and configured to couple the first sub-image light into the first waveguide; and
a first out-coupling grating on the first surface and spaced apart from the first in-coupling grating along the first direction, the first out-coupling grating configured to couple the first sub-image light out of the first waveguide;
wherein a grating direction of the first in-coupling grating has a first angle θ1 relative to the first direction, a grating direction of the first out-coupling grating has a second angle θ2 relative to the first direction, each of the first angle θ1 and the second angle θ2 is non-zero, and the grating direction of the first in-coupling grating is opposite to the grating direction of the first out-coupling grating.

2. The optical waveguide structure according to claim 1, wherein the first angle θ1 satisfies: -15° ≤ θ1 < 0° or 0° < θ1 ≤ 15°, and the second angle θ2 satisfies: -180° < θ2 ≤ -165° or 165° ≤ θ2 < 180°.

3. The optical waveguide structure according to claim 1, wherein a refractive index of the first waveguide is in a range from 1.3 to 2.5.

4. The optical waveguide structure according to claim 1, wherein the first in-coupling grating and the first out-coupling grating each have a grating period ranging from 0.1 μm to 10 μm.

5. The optical waveguide structure according to claim 1, wherein the first in-coupling grating and the first out-coupling grating are independently selected from an amplitude grating or a phase grating.

6. The optical waveguide structure according to claim 1, further comprising a second waveguide, a second in-coupling grating, and a second out-coupling grating, wherein:
the second waveguide comprises a third surface and a fourth surface opposite to each other, and is attached to a side of the first waveguide and covers the first in-coupling grating and the first out-coupling grating;
the second waveguide is configured to guide a second sub-image light within a second wavelength range along the first direction;
the second in-coupling grating is on the third surface and configured to couple the second sub-image light into the second waveguide;
the second out-coupling grating is on the third surface and spaced apart from the second in-coupling grating along the first direction, the second out-coupling grating configured to couple the second sub-image light out of the second waveguide;
wherein a grating direction of the second in-coupling grating has a third angle θ3 relative to the first direction, a grating direction of the second out-coupling grating has a fourth angle θ4 relative to the first direction, the third angle θ3 and the fourth angle θ4 are non-zero, and the grating direction of the second in-coupling grating is opposite to the grating direction of the second out-coupling grating.

7. The optical waveguide structure according to claim 6, wherein the third angle θ3 satisfies: -15° ≤ θ3 < 0° or 0° < θ3 ≤ 15°, and the fourth angle θ4 satisfies: -180° < θ4 ≤ -165° or 165° ≤ θ4 < 180°.

8. The optical waveguide structure according to claim 6, wherein a refractive index of the second waveguide is in a range from 1.3 to 2.5.

9. The optical waveguide structure according to claim 6, wherein the second in-coupling grating and the second out-coupling grating each have a grating period ranging from 0.1 μm to 10 μm.

10. The optical waveguide structure according to claim 6, wherein the second in-coupling grating and the second out-coupling grating are independently selected from an amplitude grating or a phase grating.

11. The optical waveguide structure according to claim 1, further comprising a plurality of waveguides stacked on the first waveguide, a plurality of in‑coupling gratings and a plurality of out‑coupling gratings;
wherein a side of each of the plurality of waveguides comprises a corresponding in‑coupling grating of the plurality of in‑coupling gratings and a corresponding out‑coupling grating of the plurality of out‑coupling gratings, and the corresponding in‑coupling grating and the corresponding out‑coupling grating are spaced apart from each other along the first direction;
each of the plurality of waveguides is configured to guide a sub‑image light along the first direction; and
for each of the plurality of waveguides, a grating direction of the corresponding in-coupling grating forms a non-zero angle with the first direction, a grating direction of the corresponding out-coupling grating forms a non-zero angle with the first direction, and the grating direction of the corresponding in-coupling grating and the grating direction of the corresponding out-coupling grating are opposite to each other.

12. An augmented reality (AR) display device, comprising:
a display panel configured to emit image light; and
an optical waveguide structure configured to receive the image light, the optical waveguide structure comprising:
a first waveguide comprising a first surface and a second surface opposite to each other, the first waveguide configured to guide a first sub-image light within a first wavelength range of the image light along a first direction;
a first in-coupling grating on the first surface and configured to couple the first sub-image light into the first waveguide; and
a first out-coupling grating on the first surface and spaced apart from the first in-coupling grating along the first direction, the first out-coupling grating configured to couple the first sub-image light out of the first waveguide;
wherein a grating direction of the first in-coupling grating has a first angle θ1 relative to the first direction, a grating direction of the first out-coupling grating has a second angle θ2 relative to the first direction, each of the first angle θ1 and the second angle θ2 is non-zero, and the grating direction of the first in-coupling grating is opposite to the grating direction of the first out-coupling grating.

13. The AR display device according to claim 12, wherein the first angle θ1 satisfies: -15° ≤ θ1 < 0° or 0° < θ1 ≤ 15°, and the second angle θ2 satisfies: -180° < θ2 ≤ -165° or 165° ≤ θ2 < 180°.

14. The AR display device according to claim 12, wherein the first in-coupling grating and the first out-coupling grating each have a grating period ranging from 0.1 μm to 10 μm.

15. The AR display device according to claim 12, wherein the first in-coupling grating and the first out-coupling grating are independently selected from an amplitude grating or a phase grating.

16. The AR display device according to claim 12, wherein the optical waveguide structure further comprises a second waveguide, a second in-coupling grating, and a second out-coupling grating;
the second waveguide comprises a third surface and a fourth surface opposite to each other, and is attached to a side of the first waveguide and covers the first in-coupling grating and the first out-coupling grating;
the second waveguide is configured to guide a second sub-image light within a second wavelength range along the first direction;
the second in-coupling grating is on the third surface and configured to couple the second sub-image light into the second waveguide;
the second out-coupling grating is on the third surface and spaced apart from the second in-coupling grating along the first direction, the second out-coupling grating configured to couple the second sub-image light out of the second waveguide; and
a grating direction of the second in-coupling grating has a third angle θ3 relative to the first direction, a grating direction of the second out-coupling grating has a fourth angle θ4 relative to the first direction, the third angle θ3 and the fourth angle θ4 are non-zero, and the grating direction of the second in-coupling grating is opposite to the grating direction of the second out-coupling grating.

17. The AR display device according to claim 16, wherein the third angle θ3 satisfies: -15° ≤ θ3 < 0° or 0° < θ3 ≤ 15°, and the fourth angle θ4 satisfies: -180° < θ4 ≤ -165° or 165° ≤ θ4 < 180°.

18. The AR display device according to claim 16, wherein he second in-coupling grating and the second out-coupling grating each have a grating period ranging from 0.1 μm to 10 μm.

19. The AR display device according to claim 16, wherein the second in-coupling grating and the second out-coupling grating are independently selected from an amplitude grating or a phase grating.

20. The AR display device according to claim 12, wherein the optical waveguide structure further comprises a plurality of waveguides stacked on the first waveguide, a plurality of in‑coupling gratings and a plurality of out‑coupling gratings;
a side of each of the plurality of waveguides comprises a corresponding in‑coupling grating of the plurality of in‑coupling gratings and a corresponding out‑coupling grating of the plurality of out‑coupling gratings, and the corresponding in‑coupling grating and the corresponding out‑coupling grating are spaced apart from each other along the first direction;
each of the plurality of waveguides is configured to guide a sub‑image light along the first direction; and
for each of the plurality of waveguides, a grating direction of the corresponding in-coupling grating forms a non-zero angle with the first direction, a grating direction of the corresponding out-coupling grating forms a non-zero angle with the first direction, and the grating direction of the corresponding in-coupling grating and the grating direction of the corresponding out-coupling grating are opposite to each other.
